(19) United States
(12) Patent Application Publication
(10) Pub. No.: US 2026/0361413 A1
(43) Pub. Date: Nov. 12, 2026

(54) Transient Suppression in Downstream Multi-Band Optical Amplifiers

(71) Applicant: Ciena Corporation, Hanover, MD (US)

(72) Inventors: Andrew Pak Tao Kam, Stittsville (CA); Michael Lapp, Richmond (CA); Priyanth Mehta, Ottawa (CA); Elham Bidaki, Ottawa (CA)

(73) Assignee: Ciena Corporation, Hanover, MD (US)

(21) Appl. No.: 19/203,326

(22) Filed: May 9, 2025

(51) Int. Cl. H04B 10/564; H04B 10/079; H04B 10/572

(52) U.S. Cl. CPC H04B 10/564; H04B 10/07953; H04B 10/572

(57) ABSTRACT

In-Line Amplifiers (ILAs) may be arranged in multi-band optical line systems for communicating signals over multiple wavelength bands. In one implementation, an ILA module includes a first amplifier associated with a first wavelength band of the multiple wavelength bands. The first amplifier is configured to receive a first optical waveform from an adjacent upstream optical element, the first optical waveform being transmitted over the first wavelength band. In response to obtaining a first indication that a power level of the first optical waveform is acceptable, the first amplifier is configured to output an amplified version of the first optical waveform according to characteristics of the first wavelength band. In response to obtaining a second indication that the power level of the first optical waveform is unacceptable, the first amplifier is configured to output a first Amplified Spontaneous Emission (ASE) waveform according to the characteristics of the first wavelength band.

### TECHNICAL FIELD

The present disclosure generally relates to optical communication networks. More particularly, the present disclosure relates to systems and methods for suppressing the effects of transients in a multi-band optical line system by adjusting a power level of an adjacent downstream amplifier.

### BACKGROUND

Generally, optical communication systems are configured to transmit optical signals that are contained within dozens of optical channels constituting a single optical wavelength band. For example, the C-band is an optical wavelength band that has been used for decades and includes frequency channels having wavelengths ranging from about 1525 nm to about 1565 nm. In recent years, the L-band has also been introduced and includes wavelengths ranging from about 1570 nm to about 1610 nm. Optical systems employing both C-band and L-band signals may be referred to as C+L-band systems or multi-band systems. Some developers plan to expand the number of optical channels and wavelength bands to enable an even greater amount of optical traffic within these optical communication systems. In a C+L-band system, each band may be fully loaded with either traffic channels or dummy (filler) Amplified Spontaneous Emission (ASE) channels. A fully loaded system minimizes fluctuations in performance due to localized spectral changes due to adding or deleting channels and/or due to individual channel faults. However, in the scenario of a failure of an entire band (e.g., the entire C-band), which may be caused by hardware and/or software failures, the propagation and spectral shape of the surviving band (e.g., the L-band) can be significantly impacted due to a change in the amount of Stimulated Raman Scattering (SRS) present. Therefore, there is a need for systems and methods to account for performance degradation in surviving optical bands when another wavelength band fails.

### BRIEF SUMMARY

According to various implementations of the present disclosure, an In-Line Amplifier (ILA) module may be arranged in an optical line system that is configured for communicating optical signals within multiple optical wavelength bands. In one implementation, the ILA module may include at least a first amplifier associated with a first wavelength band of the multiple wavelength bands. The first amplifier is configured to receive a first optical waveform from an adjacent upstream optical element via an upstream fiber span, where the first optical waveform is transmitted over the first wavelength band. In response to obtaining a first indication that a power level of the first optical waveform is acceptable, the first amplifier is configured to output an amplified version of the first optical waveform according to characteristics of the first wavelength band. In response to obtaining a second indication that the power level of the first optical waveform is unacceptable, the first amplifier is configured to output a first Amplified Spontaneous Emission (ASE) waveform according to the characteristics of the first wavelength band.

In some embodiments, the ILA may further include a control device connected to a control port of the first amplifier. The control device may be configured to receive a control signal from the adjacent upstream optical element. In response to the control signal signifying a first upstream condition in which the power level of the first optical waveform is above a predetermined threshold, the control device is configured to provide the first indication to the control port. In response to the control signal signifying a second upstream condition in which the power level of the second optical waveform is below the predetermined threshold, the control device is configured to provide the second indication to the control port. The control device may also be configured to receive the control signal from an upstream Optical Performance Monitoring (OPM) device of the adjacent upstream optical element, where the upstream OPM device may be configured to analyze the power level of the first optical waveform with respect to the predetermined threshold, where the predetermined threshold may be associated with the first wavelength band. The action of outputting the first ASE waveform may be configured to suppress a transient condition detected in the adjacent upstream optical element by substantially equalizing a power level at the output of the first amplifier.

According to further implementations, the ILA module may also include a second amplifier associated with a second wavelength band of the multiple wavelength bands, wherein the second amplifier may be configured to receive a second optical waveform from the adjacent upstream optical element via the upstream fiber span, and wherein the second optical waveform is transmitted over the second wavelength band. In response to obtaining a third indication that a power level of the second optical waveform is acceptable, the second amplifier is configured to output an amplified version of the second optical waveform according to characteristics of the second wavelength band. In response to obtaining a fourth indication that the power level of the second optical waveform is unacceptable, the second amplifier is configured to output a second ASE waveform according to the characteristics of the second wavelength band.

The control device may also be connected to a control port of the second amplifier and may be configured to receive a control signal from the adjacent upstream optical element. In response to the control signal signifying a first upstream condition in which the power level of the second optical waveform is above a predetermined threshold, the control device is configured to provide the third indication to the control port. In response to the control signal signifying a second upstream condition in which the power level of the first optical waveform is below the predetermined threshold, the control device is configured to provide the fourth indication to the control port. The first wavelength band, for example, may be the C-band ranging from about 1525 nm to about 1565 nm, and the second wavelength band may be the L-band ranging from about 1570 nm to about 1610 nm. When either the first optical waveform in the C-band or the second optical waveform in L-band is defective, the control device may be configured cause an amplifier corresponding to the defective optical waveform to replace the defective optical waveform with its respective ASE waveform to reduce negative effects on a surviving wavelength band.

The multiple wavelength bands described herein may include two or more of a) an O-band ranging from about 1260 nm to about 1360 nm, b) an E-band ranging from about 1360 nm to about 1460 nm, c) an S-band ranging from about 1460 nm to about 1525 nm, d) a C-band ranging from about 1525 nm to about 1565 nm, e) an L-band ranging from about 1570 nm to about 1610 nm, and f) a U-band ranging from about 1625 nm to about 1675 nm. When one or more optical waveforms transmitted over the O-band, E-band, S-band, C-band, L-band, and U-band have a power level below a predetermined threshold for the respective wavelength band, the control device may be configured to cause each corresponding amplifier to replace its defective optical waveform with its corresponding ASE waveform to reduce negative effects on one or more surviving wavelength bands.

In some cases, a power level of the first ASE waveform may be substantially the same as the power level of the first optical waveform when fully loaded with data channels. When an upstream issue is resolved by the adjacent upstream optical device to thereby change a status of the power level of the first optical waveform from unacceptable to acceptable, the first amplifier may be configured to replace the ASE waveform with the amplified version of the first optical waveform. For example, replacing the first optical waveform with the first ASE waveform may be configured to reduce negative influences on one or more surviving wavelength bands having one or more power levels above corresponding predetermined thresholds. The action of reducing negative influences, for example, may include a) mitigating fluctuations in the one or more surviving wavelength bands, b) mitigating an impact of Stimulated Raman Scattering (SRS) in the one or more surviving wavelength bands, c) reducing a tilt effect in the one or more surviving wavelength bands, and/or d) improving a Signal-to-Noise Ratio (SNR) parameter in optical channels in the one or more surviving wavelength bands.

In some embodiments, the ILA module may also include a Dynamic Gain Flattening Filter (DGFF) connected to the output of the first amplifier. The control device may be further configured to reconfigure a target power profile of the DGFF based on a control signal received from the adjacent upstream optical element. Also, the ILA module may include a supplemental amplifier connected to an output of the DGFF. Each of the first amplifier and supplemental amplifier, for example, may be an Erbium-Doped Fiber Amplifier (EDFA).

The ILA module, in various implementations, may further include an Optical Performance Monitoring (OPM) device connected to an output of the ILA module that leads to an adjacent downstream optical element via a downstream fiber span. The OPM device, for example, may be configured to transmit a downstream switching control signal to a downstream control device of the adjacent downstream optical element. The OPM device may further be configured to relay a control signal received from the adjacent upstream optical element to the downstream control device of the adjacent downstream optical element. Upon the OPM device detecting a wavelength band of the multiple wavelength bands having a power level below a predetermined threshold, the OPM device may configure the downstream switching control signal to instruct an associated amplifier to output an ASE waveform. The adjacent downstream optical element, for instance, may be a terminal node having a demultiplexer and multiple receivers.

An optical element, according to additional embodiments, may be arranged in an optical line system configured for communicating optical signals within multiple optical wavelength bands. The optical element may include multiple amplifiers, where each amplifier is configured to amplify an optical waveform within a respective wavelength band of the multiple wavelength bands. The optical element may also include multiple Optical Performance Monitoring (OPM) devices, where each OPM device may be connected to an output of a corresponding amplifier. Each OPM device, for example, may be configured to detect a power level of the respective optical waveform, such that, in response to determining that the power level falls below a predetermined threshold associated with the respective wavelength band, the respective OPM device may be configured to send a control signal to a controller of an adjacent downstream optical element to instruct a corresponding amplifier to replace the respective optical waveform with an Amplified Spontaneous Emission (ASE) waveform. The optical element, according to some embodiments, may be an In-Line Amplifier (ILA) module or a terminal node having multiple transmitters and a multiplexer.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a diagram illustrating an optical line system having multiple In-Line Amplifier (ILA) sites between terminal nodes, according to various embodiments.

FIG. 2 is a diagram illustrating a nominal effect of Stimulated Raman Scattering (SRS) in a two-band optical system after propagation over a fiber span, according to various embodiments.

FIG. 3 is a diagram illustrating an effect of SRS in a two-band optical system after propagation over a fiber span and when one band fails, according to various embodiments.

FIG. 4 is a diagram illustrating a single stage amplifier employed at an ILA site, according to various embodiments.

FIG. 5 is a diagram illustrating a dual stage amplifier employed at an ILA site, according to various embodiments.

FIG. 6 is a block diagram illustrating one of the Optical Performance Monitoring (OPM) devices shown in FIGS. 4 and 5, according to various embodiments.

FIG. 7 is a diagram illustrating different possible effects of SRS in a two-band optical system after propagation over multiple fiber spans, according to various embodiments.

FIG. 8 is a diagram illustrating different possible effects of SRS in a four-band optical system after propagation over multiple fiber spans, according to various embodiments.

FIGS. 9A and 9B are graphs showing test results of an optical line system of the present disclosure in comparison with conventional systems.

### DETAILED DESCRIPTION

The present disclosure relates to systems and methods for maintaining power levels in an optical communication system. In a multi-band optical communication system (e.g., a C+L band network), each band is typically fully loaded with either optical data traffic channels or Amplified Spontaneous Emission (ASE) channels. For example, the ASE channels may generally be noise channels used primarily to match the power level of a missing optical channel. However, at times, an entire optical wavelength band (e.g., the C-band) may fail. The systems and methods of the present disclosure are configured to handle situations in which an entire band (or a significant portion of the band) is missing, faulty, defective, etc.

When an optical band is fully loaded with regular optical data traffic signals or replaced with ASE signals, the fully loaded system is able to minimize fluctuations in performance due to localized spectral changes from capacity adds/deletes or individual channel faults. However, when the regular optical signals are missing or defective, they may be replaced with ASE. When an entire band fails, the propagation and spectral shape of the surviving bands can be significantly impacted due to a change in the amount of Stimulated Raman Scattering (SRS) present. Therefore, there may be various ways that ASE may be introduced into an optical line system to substantially match a power level of the missing optical channels.

In previous approaches aiming to equalize power levels when a band fails, the gain and tilt of the surviving band may be adjusted at every downstream In-Line Amplifier (ILA) site to try to meet the same interpolated linear tilt profile that was present before the band failure. This solution may attempt to reduce Signal-to-Noise Ratio (SNR) impact but might only be able to partially correct the power profile of the surviving band and does not recover the failed band. Also, it may not be able to reproduce the same spectral target and compensate fully. As a result, the SNR impact from band failure may end up being worse, based on the function of a large number of fiber spans without band power substitution. In some cases, changes at every downstream ILA site of the failed band may increase the recovery time and system complexity. Therefore, the embodiments of the present disclosure are configured to provide an alternative strategy for overcoming the issue of power degradation in the surviving bands of a multi-band optical system.

### Optical Line System

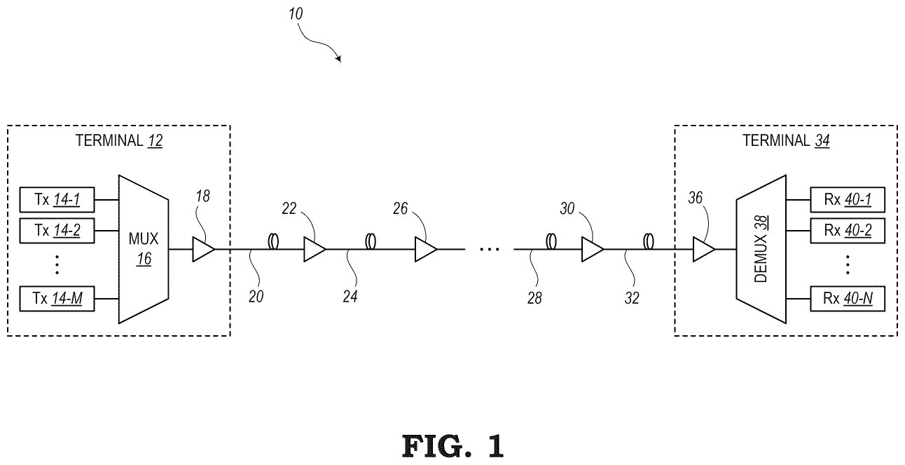

FIG. 1 is a diagram illustrating an embodiment of an optical line system 10 having multiple In-Line Amplifier (ILA) sites positioned between terminal nodes. As shown in this embodiment, the optical line system 10 includes a terminal 12 (or node) having multiple transmitters (Tx) 14-1, 14-2, . . . , 14-M connected to inputs of a multiplexer (mux) 16. The terminal 12 also includes an amplifier 18 (e.g., Erbium-Doped Fiber Amplifier (EDFA) or the like) connected at the output of the mux 16.

The optical line system 10 further includes a first fiber span 20, a first ILA site 22, a second fiber span 24, a second ILA site 26, an x^{th} fiber span 28, an x^{th} ILA site 30, and an (x+1)^{th} fiber span 32, in which the optical line system 10 includes a number of ILA sites equal to x and a number of fiber spans equal to x+1. According to typical optical system deployments, the number x may be any suitable number, and, in some embodiments, may be as high as several dozen or more.

The (x+1)^{th} fiber span 32 is connected to another terminal 34 (or node), configured to receive optical signals from the terminal 12 in a direction shown in FIG. 1 from left to right. It may be noted that the optical line system 10 may include bi-directional communication. However, for the sake of simplifying the explanation of the various systems and methods of the present disclosure, a single propagation direction is shown. The terminal 34 includes an amplifier 36 (e.g., Raman amplifier, EDFA, etc.) connected to an input of a demultiplexer (demux) 38. The outputs of the demux 38 are connected to a plurality of receivers (Rx) 40-1, 40-2, . . . , 40-N.

### Power Attenuation of Optical Signals Propagating Over a Fiber Span

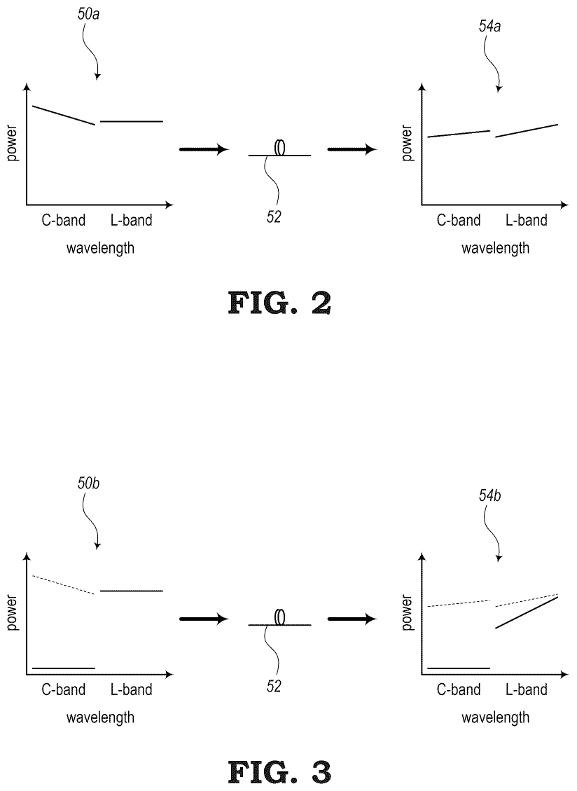

FIG. 2 is a diagram illustrating an example of a nominal effect of Stimulated Raman Scattering (SRS) in a two-band optical system (i.e., C+L-band system) after propagation over a fiber span 52. In this example, the two-band optical system is configured to handle C-band optical signals having wavelengths ranging from about 1525 nm to about 1565 nm and L-band optical signals having wavelengths ranging from about 1570 nm to about 1610 nm. At an upstream site (e.g., the terminal 12), C+L signals are generated having power levels shown in the graph 50a. These C+L signals are propagated through the fiber span 52 (e.g., the first fiber span 20). Because of SRS in the fiber span 52, the C-band and L-band signals lose a certain amount of power over the fiber span 52 depending on various factors, such as the frequency of the channels within each band, parameters of the fiber span 52, length of the fiber span 52, etc. Thus, at the end of the fiber span 52, the power levels 54a are attenuated, as shown in the graph 54a, according to this example. This may be considered to be a somewhat normal power attenuation pattern for a fully operational optical system with no significant faults or defects.

FIG. 3 is a diagram illustrating an example of a situation in a two-band optical line system (e.g., C+L-band system) where there is a defect in one of the bands (e.g., the C-band). In this example, the C-band is entirely lost, as shown in the graph 50b. It may be noted that the C-band signal might be completely lost, or its power may have been reduced significantly (e.g., below a certain predetermined threshold level). Thus, an effect of SRS in this system after propagation over the fiber span 52 is that the L-band is affected such that it experiences a significantly greater attenuation as compared to the normal or non-defective power response as shown in FIG. 2. That is, the graph 54b shows an example of additional power attenuation of the L-band when the optical signals (having a defective C-band) are transmitted over the fiber span 52. It may be noted that similar attenuation effects may result in the case where the C-band is operational while the L-band is dropped or significantly reduced before propagation over the fiber span 52. Also, it may be noted in FIG. 3 that the L-band does not yet experience any changes before propagation as compared with the normal propagation shown in FIG. 2 but instead experiences greater attenuation throughout the propagation over the fiber span 52.

Since a defective or missing optical wavelength band inherently leads to an increased power attenuation profile on the remaining/surviving band (or bands) in a multi-band optical system, attempts to maintain a suitable power level on each band can lead to better communication results in the system. One solution may include fully loading each of the optical wavelength bands with data channels and then filling in empty or missing channels with dummy ASE noise. Again, a fully loaded system will reduce fluctuations in the performance of the surviving bands and reduce the impact of Stimulated Raman Scattering (SRS). The fully loaded system can also reduce the negative impact of SNR in the optical traffic in the surviving band or bands that could lead to traffic hits. The exact magnitude of SNR impact, for instance, may be complex and may be dependent on various conditions, such as the band that failed, the launch power profile, the optical fiber type, and propagation distance over the fiber spans, etc.

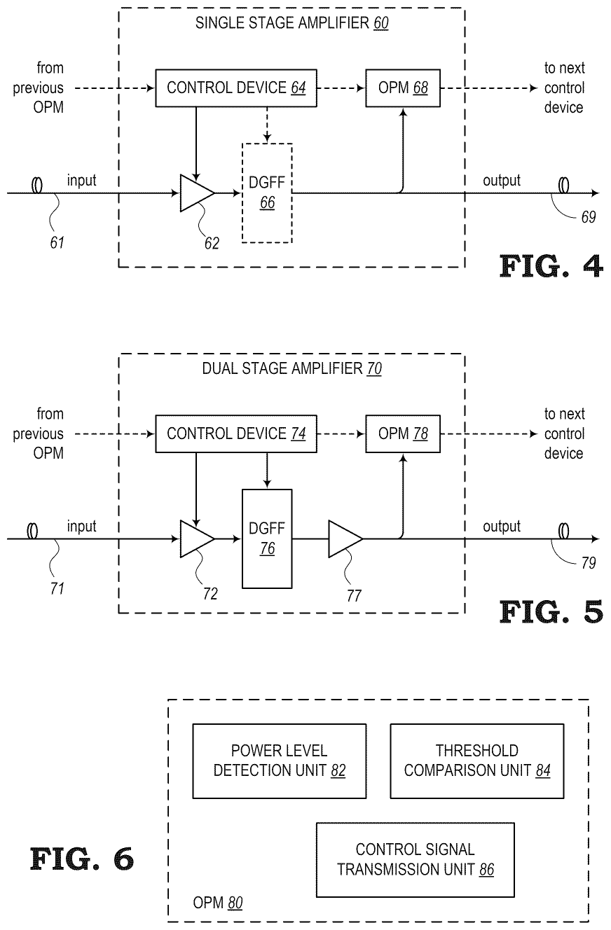

Thus, FIGS. 2 and 3 conceptually illustrate the effect of SRS on the optical spectrum after propagation through the fiber span 52 under nominal conditions (FIG. 2) with both C-band and L-band present and under a C-band failure condition (FIG. 3). Thus, a goal may include mitigating the SNR impact of the surviving band under optical band failure conditions by leveraging the downstream ILA sites 22, 26, . . . , 30 to compensate for the failure conditions. This may be accomplished with or without a Dynamic Gain Flattening Filter (DGFF) present, as shown in FIGS. 4 and 5. The solutions may be embodied in a unique control mechanism built into various networking elements of the optical communication systems. Also, the ILA sites 22, 26, . . . , 30 may include either a single stage amplifier configuration or a dual stage amplifier configurations, as shown in FIGS. 4 and 5.

### Amplifier Circuitry at ILA Sites

FIG. 4 is a diagram illustrating an embodiment of a single stage amplifier 60 that may be employed at any of a plurality of ILA sites in an optical line system. For example, the single stage amplifier 60 may be installed at one or more of the ILA sites 22, 26, . . . , 30, etc. shown in FIG. 1. According to various embodiments, the single stage amplifier 60 may include a controller and Optical Performance Monitoring (OPM) devices that may be incorporated in a control plane of the optical line system. As such, optical data signals may be propagated over fiber spans, while control signals may be communicated over any suitable transmission lines of the control plane for enabling control actions to the components (e.g., the single stage amplifier 60) that affect regular data communications.

As shown in the embodiment of FIG. 4, the single stage amplifier 60 includes an amplifier 62 (e.g., EDFA) configured to receive regular optical data signals over an upstream fiber span 61. The upstream fiber span 61 is configured to transmit the optical data signals from an adjacent upstream component (e.g., terminal 12, ILA site 22, 26, . . . , 30, etc.). Thus, the single stage amplifier 60 may be configured in the nearest downstream location (via the corresponding fiber span 61) from this adjacent upstream component.

The amplifier 62, under normal conditions, is configured to receive the regular optical data signals (via the upstream fiber span 61) and amplify the optical data signals. The amplifier 62 is also configured to supply an amplified version of these optical data signals at its output. However, the amplifier 62 is further configured to perform additional functions when the signals received from the upstream fiber span 61 are unacceptable. For example, if the power level of the optical signals is below a predetermined threshold level and are therefore unsuitable, a control device 64 is configured to provide an indication to a control port of the amplifier 62 to instruct the amplifier 62 to output an ASE waveform instead. Thus, the control port of the amplifier 62 is configured to receive a control signal from a control device 64.

The control device 64 is configured to control the amplifier 62 by providing a certain indication. A first indication may simply instruct the amplifier 62 to perform according to normal functions and amplify the received waveform according to the respective wavelength band characteristics. A second indication may instruct the amplifier 62 to provide an ASE waveform, which may be generated in the amplifier 62 itself.

In some embodiments, the single stage amplifier 60 may also include a DGFF 66 configured to receive the amplifier output of the amplifier 62. The control device 64 is configured to receive control signals from an OPM device of the adjacent upstream component over the control plane. Based on these control signals, the control device 64 can switch the amplifier 62 between the two possible outputs and/or can adjust the DGFF 66.

It may be noted that the single stage amplifier 60 may be applicable for one optical wavelength band, while another single stage amplifier (or a dual stage amplifier as shown in FIG. 5) can be used for another optical wavelength band (or bands). For example, if the single stage amplifier 60 is used for the C-band and a fault is detected in the upstream C-band, then the control device 64 may be configured to select the ASE waveform as a substitute for the defective or missing C-band waveform. In the case where the single stage amplifier 60 is used for the L-band and a fault is detected in the upstream C-band, the control device 64 may be configured to keep the original input to the amplifier 62 for receiving the operational L-band waveform from upstream, while the control device 64 may further control the DGFF 66 to adjust the L-band waveform to make up for the extra power attenuation caused by the faulty C-band as described with respect to FIG. 3.

The premise of the control mechanism is that under a band failure condition at any given site, the nearest adjacent downstream amplifier (e.g., the single stage amplifier 60) may be configured to counteract the excessive power attenuation caused by the failed band. Also, because of the differences in suitable power levels with respect to each band, the amplifier 62 is configured to generate a band-specific ASE waveform accordingly. The DGFF 66 is also actively re-configured to meet the target power profile to attempt to match the profile before the band failure.

Furthermore, the single stage amplifier 60 includes an Optical Performance Monitoring (OPM) device 68, configured to monitor the power level at the output of the amplifier 62 or DGFF 66 (when present). Also, this output is provided on a downstream fiber span 69 connected to an adjacent downstream optical element, which may include the same or similar configuration for controlling the selection of optical signals or ASE, controlling DGFF adjustments, etc.

FIG. 5 is a diagram illustrating an embodiment of a dual stage amplifier 70 that may be employed at any of a plurality of ILA sites in an optical line system. For example, the dual stage amplifier 70 may be installed at one or more of the ILA sites 22, 26, . . . , 30, etc. shown in FIG. 1. According to various embodiments, the dual stage amplifier 70 may include a controller and Optical Performance Monitoring (OPM) devices that may be incorporated in a control plane of the optical line system. As such, optical data signals may be propagated over fiber spans while control signals may be communicated over any suitable transmission lines of the control plane for enabling control actions to the components that may be intended to control the regular data communications.

As shown in the embodiment of FIG. 5, the dual stage amplifier 70 includes a first amplifier 72 (e.g., EDFA) configured to receive regular optical data signals over an upstream fiber span 71. The upstream fiber span 71 is configured to transmit the optical data signals from an adjacent upstream component (e.g., terminal 12, ILA site 22, 26, . . . , 30, etc.). Thus, the dual stage amplifier 70 may be configured in the nearest downstream location (via the corresponding fiber span 71) from this adjacent upstream component.

The amplifier 72, under normal conditions, is configured to receive the regular optical data signals (via the upstream fiber span 71) and amplify the optical data signals. The amplifier 72 is also configured to supply an amplified version of these optical data signals at its output. However, the amplifier 72 is further configured to perform additional functions when the signals received from the upstream fiber span 71 are unacceptable. For example, if the power level of the optical signals is below a predetermined threshold level such that the optical signals would be unsuitable, a control device 74 is configured to provide an indication to a control port of the amplifier 72 to instruct the amplifier 72 to output an ASE waveform instead. Thus, the control port of the amplifier 72 is configured to receive a control signal from a control device 74.

The control device 74 is configured to control the amplifier 72 by providing a certain indication. A first indication may simply instruct the amplifier 72 to perform according to normal functions and amplify the received waveform according to the respective wavelength band characteristics. A second indication may instruct the amplifier 72 to provide an ASE waveform, which may be generated in the amplifier 72 itself.

The control device 74 is configured to control the amplifier 72 by selecting one an input for amplification and for providing the amplified waveform to its output. The dual stage amplifier 70 further includes a DGFF 76 configured to receive the output of the amplifier 72. The control device 74 is configured to receive control signals from an OPM device of the adjacent upstream optical component. Based on these control signals, the control device 74 can switch between the input to the amplifier 72 or ASE and/or adjust the DGFF 76.

It may be noted that the dual stage amplifier 70 may be applicable for one optical wavelength band, while another dual stage amplifier (or a single stage amplifier as shown in FIG. 4) can be used for the other optical wavelength band (or bands). For example, if the dual stage amplifier 70 is used for the C-band and a fault is detected in the upstream C-band, then the control device 74 may be configured to select the ASE waveform as a substitute for the defective or missing C-band waveform. In the case where the dual stage amplifier 70 is used for the L-band and a fault is detected in the upstream C-band, the control device 74 may be configured to keep the first input to the amplifier 72 active to receive the operational L-band waveform, while the control device 74 may further control the DGFF 76 to adjust the L-band waveform to make up for the extra power attenuation caused by the faulty C-band as described with respect to FIG. 3.

The premise of the control mechanism is that under a band failure condition at any given site, the nearest adjacent downstream amplifier (e.g., the dual stage amplifier 70) may be configured to counteract the excessive power attenuation caused by the failed band. Also, because of the differences in suitable power levels with respect to each band, the amplifier 72 is configured to generate a band-specific ASE waveform accordingly. The DGFF 76 is also actively re-configured to meet the target power profile to attempt to match the profile before the band failure.

Furthermore, the dual stage amplifier 70 includes a second amplifier 77 (e.g., EDFA), which may be configured to provide additional amplification as needed and may work with the DGFF 76 to amplify and flatten the power profile to attempt to match suitable power profiles that may be present before propagation along the upstream fiber span 71. Also, the dual stage amplifier 70 includes an OPM device 78, configured to monitor the power level at the output of the second amplifier 77. Also, the data output is provided on a downstream fiber span 79 connected to an adjacent downstream optical element, which may include the same or similar configuration for controlling the selection of optical signals or ASE, controlling DGFF adjustments, etc.

### Optical Performance Monitoring (OPM) Device

FIG. 6 is a block diagram illustrating an embodiment of an OPM device 80, such as one of the OPM devices 68, 78 shown in FIGS. 4 and 5. In some embodiments, the OPM device 80 may include a computing system or may be configured with telemetry devices for communicating with a computing system, whereby the computing system may be part of the control plane for communicating control signals to the nearest downstream components to control actions to account for failures of an entire optical wavelength band, when such faults are detected.

As shown in this embodiment, the OPM device 80 includes a power level detection unit 82. The power level detection unit 82 is configured to determine a power profile over multiple channels of an optical wavelength band under observation. Again, the OPM device 80 may be applicable to a single optical wavelength band for analyzing power on that band. The OPM device 80 of FIG. 6 further includes a threshold comparison unit 84, which may be configured to compare the power profile detected by the power level detection unit 82 to a predetermined threshold level (or profile) that represents a suitable power level. For example, if the entire band (e.g., C-band) is missing (as shown in FIG. 3), the power level over the entire band may essentially be zero. In other embodiments, a largely attenuated signal may be indicative of a faulty band, whereby the band may fall below a predetermined threshold. Based on a condition in which the band falls below the threshold, a control signal transmission unit 86 is configured to communicate control signals to the next downstream optical component in order to instruct this component that the monitored band is faulty and needs ASE replacement.

Referring again to FIGS. 4 and 5, the communication of control signals may involve at least the control devices 64, 74 and the OPM device 66, 76. This may include forwarding control signals received from an upstream component to a downstream component as needed. Also, it may include re-monitoring the output of amplified signals to determine if the power levels are acceptable and communicating to the next component when ASE substitution may be needed. Replacing ASE at one ILA site may include the communication of control signals to downstream elements that the fully loaded ASE signals are not actual data signals but may be amplified and/or replaced by local ASE waveforms to maintain the power levels.

### Two-Band Optical System

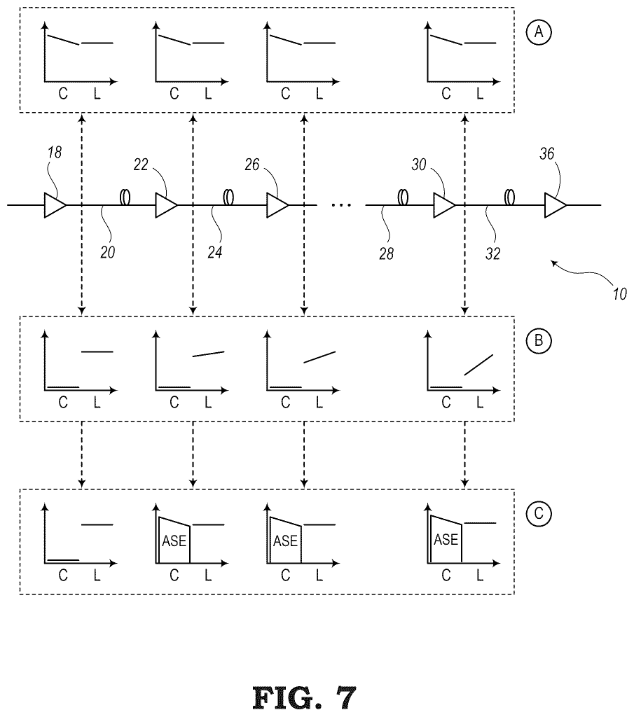

FIG. 7 is a diagram illustrating an example of different possible effects of SRS in a two-band optical system after propagation over multiple fiber spans. The portion of the optical line system 10 arranged between the end terminals is shown in FIG. 7. This portion includes the first ILA site 18, the second fiber span 20, the second ILA site 22, the third fiber span 24, the third ILA site 26, . . . , the x^{th} fiber span, and the x^{th} ILA site 30. Monitored power profiles for each of the C-band and L-band are shown at the output of the first ILA site 18, the second ILA site 22, the third ILA site 26, and the x^{th} ILA site 30.

Condition “A” shows a situation when both bands of the two-band system are operational. This shows the normal or nominal C+L-band results, where the ILA sites (with DGFF control) are configured to provide the desired output power profile.

Condition “B” shows a situation when the C-band fails at the output of the first ILA site 18 and no actions are taken to boost the L-band, which is affected by the C-band failure. The C-band failure causes the downstream L-band spectrum to be in a non-optimal power profile, which continues to deteriorate with each fiber span.

Condition “C” shows a situation where the C-band failure is detected at the output of the first ILA site 18, and actions are taken as described with respect to the embodiments of the present disclosure. The downstream ILA site 22 immediately following the C-band failed ILA (i.e., the first ILA site 18) is switched into a band-specific ASE generation mode. Also, the DGFF 66, 76 for the L-band is reconfigured to meet the target power profile before the band failure, resulting in the downstream power profiles of the surviving L-band matching that of nominal conditions. Again, the ASE waveform may be generated in the amplifiers of the remaining downstream ILA sites and/or the previous ASE signal can be amplified as usual based on the upstream fiber span to keep the L-band at the acceptable level. Also, the power profiles at the outputs of the remaining ILA sites may also be adjusted by the DGFF as needed.

### Four-Band Optical System

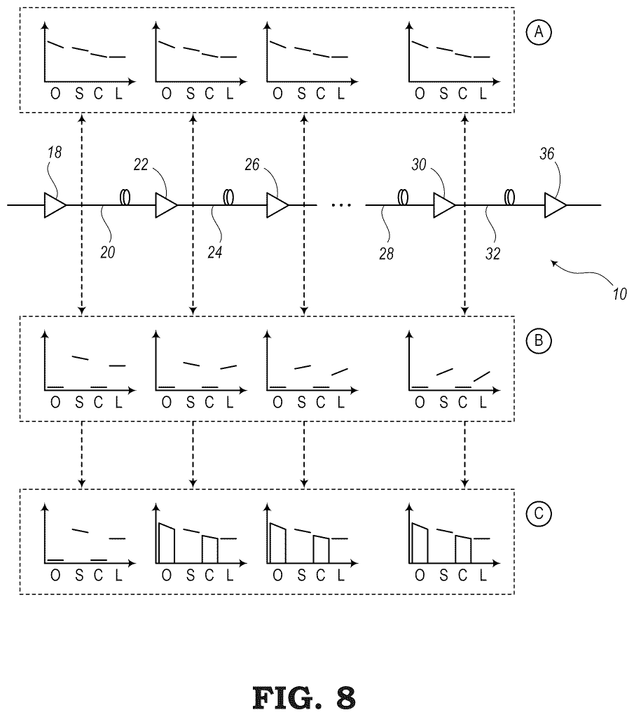

FIG. 8 is a diagram illustrating an example of different possible effects of SRS in a four-band optical system after propagation over multiple fiber spans. Again, the portion of the optical line system 10 arranged between the end terminals is shown in FIG. 8, whereby this portion includes the first ILA site 18, the second fiber span 20, the second ILA site 22, the third fiber span 24, the third ILA site 26, . . . , the x^{th} fiber span, and the x^{th} ILA site 30. However, in this example, the optical communication system is configured to utilize four different optical wavelength bands, including, for example, the O-band having a wavelength range from about 1260 nm to about 1360 nm, the S-band having a wavelength range from about 1460 nm to about 1530 nm, the C-band, and the L-band. Thus, the monitored power profiles for each of the O-band, S-band, C-band, and L-band are shown at the output of the first ILA site 18, the second ILA site 22, the third ILA site 26, and the x^{th} ILA site 30.

Condition “A” shows a situation when all four bands of the four-band system are operational. This shows the normal or nominal results, where the ILA sites (with DGFF control) are configured to provide the desired output power profile.

Condition “B” shows a situation when the O-band and C-band fail at the output of the first ILA site 18 and no actions are taken to boost the S-band and L-band, which is affected by the failure of both the O-band and C-band. The O-band and C-band failure causes the S-band spectrum and the L-band spectrum at downstream nodes to be in a non-optimal power profile, which continues to deteriorate with each fiber span.

Condition “C” shows a situation where the O-band and C-band failure is detected at the output of the first ILA site 18, and actions are taken as described with respect to the embodiments of the present disclosure. The amplifiers at the downstream ILA site 22 immediately following the failed ILA (i.e., the first ILA site 18) are switched into band-specific ASE generation modes. Also, the DGFFs 66, 76 for the S-band and L-band are reconfigured to meet the target power profiles before the band failure, resulting in the downstream power profiles of the surviving bands matching that of nominal conditions. Again, the ASE waveform may be generated in the amplifiers of the remaining downstream ILA sites and/or the previous ASE signal can be amplified as usual based on the upstream fiber span to keep the L-band at the acceptable level. Also, the power profiles at the outputs of the remaining ILA sites may also be adjusted by the DGFF as needed.

It may be noted that any number of bands may be incorporated into the optical systems described herein. The bands may include C+L band channels (FIG. 7), four band channels (FIG. 8), or any configuration having at least two wavelength bands selected from the O-band, the E-band having wavelengths ranging from about 1360 nm to about 1460 nm, the S-band, the C-band, the L-band, and the U-band having wavelengths ranging from about 1625 nm to about 1675 nm.

Again, FIG. 8 shows the idea for a multi-band O-, S-, C- and L-band system similar to FIG. 7, where the diagram shows the three condition. That is, Condition A shows the nominal conditions, the ILA site(s) with DGFF control to the desired output power profile for each band, Condition B shows a band failure occurs (e.g., in the O- and C-band) causing the downstream S- and L-band spectra to be in a non-optimal power profile, and Condition C shows the downstream ILA immediately following the band failed ILA is switched into a band-specific ASE generation mode and the DGFF is reconfigured to meet the target power profile before the band failure, resulting in the downstream power profiles of the surviving bands matching that of nominal conditions.

The detailed method under band failure is described for any ILA site with or without a DGFF. Under nominal conditions, as in Condition A, a) assume the target power profile exists or has been derived a priori per transmission band, whether via baseline or span parameters, and b) define the band failure condition when the input power of a band falls below a given power threshold while other band(s) are still above the power threshold.

Under band failure conditions, as in Condition B, a) for the amplifier module(s) pertaining to the band(s) that failed, set the amplifier (or first stage if it is a dual stage amplifier) to generate broadband ASE. This can be enabled by switching the amp to fixed total output power mode or a specific ASE generation mode. Also, b) for all downstream amplifier modules with surviving bands, readjust the DGFF pixels (if present) to meet the target profile at the output of the ILA site. If a DGFF is not present, readjust the gain and/or gain tilt to minimize the delta between the target profile and achieved power profile.

Under Condition C, when the band is no longer failed and re-appears, i.e., the predefined input power threshold is cleared, revert to gain mode and restore the DGFF (if present) back to nominal operating conditions.

### Experimental Results

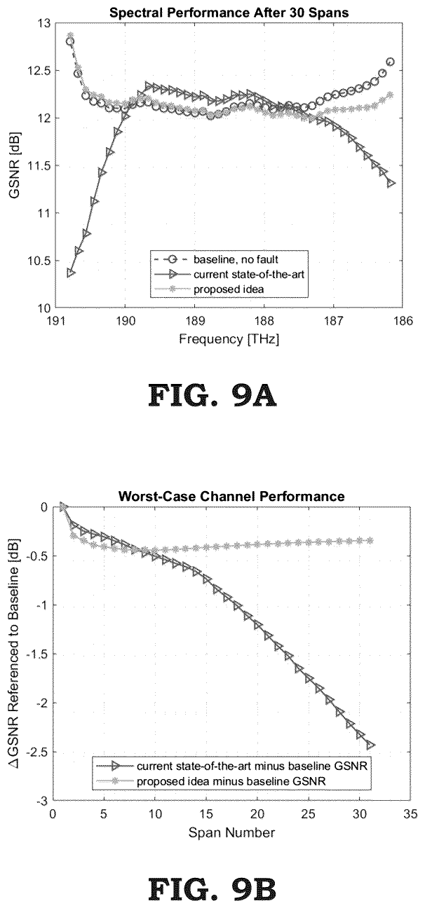

FIGS. 9A and 9B are graphs showing test results of an optical line system of the present disclosure in comparison with conventional systems. By being able to dynamically compensate for upstream band failures through any downstream ILA site using the described control system, the power and Generalized Signal-to-Noise Ratio (GSNR) impact of channels in the surviving band(s) is limited to a single span, instead of embodiments which include the entire propagated Optical Multiplex Section (OMS). The benefits on an example 30-span point-to-point dense ILA network in shown in the graphs, where a C-band failure occurs at the head-end terminal.

In the graphs, the Baseline is the default GSNR performance without band failure. The Current State-of-the-Art represents certain embodiments of control techniques that attempt to maintain the GSNR over the bandwidth. However, because of the large number of fiber spans (e.g., 30 in this example), these techniques are not optimal for these situations and may essentially be problematic at the band edges. The Proposed Idea markings show the embodiments of the present disclosure being tested in comparison to other strategies. It may be seen that, after 30 spans of propagation, the GSNR performance substantially matches the un-faulted Baseline within ~0.3 dB across the whole band.

Thus, when compared against other techniques and current state-of-the-art methodologies as a function of propagation, the embodiments of the present disclosure (“Proposed Idea”) yields an improvement of ~2.2 dB GSNR after 30 spans. The relative improvement is also expected to increase as the number of spans grows beyond 30spans, for ultra-long point-to-point networks. The graphs show the L-band performance after C-band failure at the head-end terminal for a homogeneous 80 km of NDSF 30-span point-to-point dense ILA network. The graph of FIG. 9A shows the GSNR after 30 spans of propagation and the graph of FIG. 9B shows the improvements of the proposed idea as a function of span in a point-to-point dense ILA network.

### Summary of Various Implementations

According to various implementations of the present disclosure, an In-Line Amplifier (ILA) module may be arranged in an optical line system that is configured for communicating optical signals within multiple optical wavelength bands. In one implementation, the ILA module may include at least a first amplifier associated with a first wavelength band of the multiple wavelength bands. The first amplifier is configured to receive a first optical waveform from an adjacent upstream optical element via an upstream fiber span, where the first optical waveform transmitted over the first wavelength band. In response to obtaining a first indication that a power level of the first optical waveform is acceptable, the first amplifier is configured to output an amplified version of the first optical waveform according to characteristics of the first wavelength band. In response to obtaining a second indication that the power level of the first optical waveform is unacceptable, the first amplifier is configured to output a first Amplified Spontaneous Emission (ASE) waveform according to the characteristics of the first wavelength band.

In some embodiments, the ILA may further include a control device connected to a control port of the first amplifier. The control device may be configured to receive a control signal from the adjacent upstream optical element. In response to the control signal signifying a first upstream condition in which the power level of the first optical waveform is above a predetermined threshold, the control device is configured to provide the first indication to the control port. In response to the control signal signifying a second upstream condition in which the power level of the first optical waveform is below the predetermined threshold, the control device is configured to provide the second indication to the control port. The control device may also be configured to receive the control signal from an upstream Optical Performance Monitoring (OPM) device of the adjacent upstream optical element, where the upstream OPM device may be configured to analyze the power level of the first optical waveform with respect to the predetermined threshold, where the predetermined threshold may be associated with the first wavelength band. The action of outputting the first ASE waveform may be configured to suppress a transient condition detected in the adjacent upstream optical element by substantially equalizing a power level at the output of the first amplifier.

According to further implementations, the ILA module may also include a second amplifier associated with a second wavelength band of the multiple wavelength bands, wherein the second amplifier may be configured to receive a second optical waveform from the adjacent upstream optical element via the upstream fiber span, and wherein the second optical waveform is transmitted over the second wavelength band. In response to obtaining a third indication that a power level of the second optical waveform is acceptable, the second amplifier is configured to output an amplified version of the second optical waveform according to characteristics of the second wavelength band. In response to obtaining a fourth indication that the power level of the second optical waveform is unacceptable, the second amplifier is configured to output a second ASE waveform according to the characteristics of the second wavelength band.

The control device may also be connected to a control port of the second amplifier and may be configured to receive a control signal from the adjacent upstream optical element. In response to the control signal signifying a first upstream condition in which the power level of the second optical waveform is above a predetermined threshold, the control device is configured to provide the third indication to the control port. In response to the control signal signifying a second upstream condition in which the power level of the first optical waveform is below the predetermined threshold, the control device is configured to provide the fourth indication to the control port. The first wavelength band, for example, may be the C-band ranging from about 1525 nm to about 1565 nm, and the second wavelength band may be the L-band ranging from about 1570 nm to about 1610 nm. When either the first optical waveform in the C-band or the second optical waveform in L-band is defective, the control device may be configured cause an amplifier corresponding to the defective optical waveform to replace the defective optical waveform with its respective ASE waveform to reduce negative effects on a surviving wavelength band.

The multiple wavelength bands described herein may include two or more of a) an O-band ranging from about 1260 nm to about 1360 nm, b) an E-band ranging from about 1360 nm to about 1460 nm, c) an S-band ranging from about 1460 nm to about 1525 nm, d) a C-band ranging from about 1525 nm to about 1565 nm, e) an L-band ranging from about 1570 nm to about 1610 nm, and f) a U-band ranging from about 1625 nm to about 1675 nm. When one or more optical waveforms transmitted over the O-band, E-band, S-band, C-band, L-band, and U-band have a power level below a predetermined threshold for the respective wavelength band, the control device may be configured to cause each corresponding amplifier to replace its defective optical waveform with its corresponding ASE waveform to reduce negative effects on one or more surviving wavelength bands.

In some cases, a power level of the first ASE waveform may be substantially the same as the power level of the first optical waveform when fully loaded with data channels. When an upstream issue is resolved by the adjacent upstream optical device to thereby change a status of the power level of the first optical waveform from unacceptable to acceptable, the first amplifier may be configured to replace the ASE waveform with the amplified version of the first optical waveform. For example, replacing the first optical waveform with the first ASE waveform may be configured to reduce negative influences on one or more surviving wavelength bands having one or more power levels above corresponding predetermined thresholds. The action of reducing negative influences, for example, may include a) mitigating fluctuations in the one or more surviving wavelength bands, b) mitigating an impact of Stimulated Raman Scattering (SRS) in the one or more surviving wavelength bands, c) reducing a tilt effect in the one or more surviving wavelength bands, and/or d) improving a Signal-to-Noise Ratio (SNR) parameter in optical channels in the one or more surviving wavelength bands.

In some embodiments, the ILA module may also include a Dynamic Gain Flattening Filter (DGFF) connected to the output of the first amplifier. The control device may be further configured to reconfigure a target power profile of the DGFF based on a control signal received from the adjacent upstream optical element. Also, the ILA module may include a supplemental amplifier connected to an output of the DGFF. Each of the first amplifier and supplemental amplifier, for example, may be an Erbium-Doped Fiber Amplifier (EDFA).

The ILA module, in various implementations, may further include an Optical Performance Monitoring (OPM) device connected to an output of the ILA module that leads to an adjacent downstream optical element via a downstream fiber span. The OPM device, for example, may be configured to transmit a downstream switching control signal to a downstream control device of the adjacent downstream optical element. The OPM device may further be configured to relay a control signal received from the adjacent upstream optical element to the downstream control device of the adjacent downstream optical element. Upon the OPM device detecting a wavelength band of the multiple wavelength bands having a power level below a predetermined threshold, the OPM device may configure the downstream switching control signal to instruct an associated amplifier to output an ASE waveform. The adjacent downstream optical element, for instance, may be a terminal node having a demultiplexer and multiple receivers.

An optical element, according to additional embodiments, may be arranged in an optical line system configured for communicating optical signals within multiple optical wavelength bands. The optical element may include multiple amplifiers, where each amplifier is configured to amplify an optical waveform within a respective wavelength band of the multiple wavelength bands. The optical element may also include multiple Optical Performance Monitoring (OPM) devices, where each OPM device may be connected to an output of a corresponding amplifier. Each OPM device, for example, may be configured to detect a power level of the respective optical waveform, such that, in response to determining that the power level falls below a predetermined threshold associated with the respective wavelength band, the respective OPM device may be configured to send a control signal to a controller of an adjacent downstream optical element to instruct a corresponding amplifier to replace the respective optical waveform with an Amplified Spontaneous Emission (ASE) waveform. The optical element, according to some embodiments, may be an In-Line Amplifier (ILA) module or a terminal node having multiple transmitters and a multiplexer.

The embodiments of the present disclosure can eliminate SNR impact (or transients) from band failure on spans downstream of the ILA and can fully compensate for the band failed spectrum. In a dense ILA network with DGFF at each site, the SNR impact is limited to only one span. This solution may institute system changes up to the first ILA with DGFF upon band failure in the section, which, in a dense ILA network, greatly reduces the number of sites needing to make adjustments to reduce the recovery time and system complexity.

For instance, the embodiments of the present disclosure may include certain novel features with respect to previous systems for maintaining power levels, especially in multi-band optical systems having a large number of fiber spans from one terminal to another. For example, some points of novelty may include a) the dynamic ASE generation upon band failure, b) the dynamic DGFF re-equalization of generated ASE, c) single span transient suppression, and/or d) multi-span transient suppression. As such, the SNR impact of band failure may be limited to only the first span, or the first span across multiple rails (for multi-rail solutions).

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. An In-Line Amplifier (ILA) module arranged in a multi-band optical line system configured for communicating signals within multiple wavelength bands, the ILA module comprising at least a first amplifier associated with a first wavelength band of the multiple wavelength bands,
wherein the first amplifier is configured to receive a first optical waveform from an adjacent upstream optical element via an upstream fiber span, the first optical waveform transmitted over the first wavelength band,
wherein, in response to obtaining a first indication that a power level of the first optical waveform is acceptable, the first amplifier is configured to output an amplified version of the first optical waveform according to characteristics of the first wavelength band, and
wherein, in response to obtaining a second indication that the power level of the first optical waveform is unacceptable, the first amplifier is configured to output a first Amplified Spontaneous Emission (ASE) waveform according to the characteristics of the first wavelength band.

2. The ILA module of claim 1, further comprising a control device connected to a control port of the first amplifier,
wherein the control device is configured to receive a control signal from the adjacent upstream optical element,
wherein, in response to the control signal signifying a first upstream condition in which the power level of the first optical waveform is above a predetermined threshold, the control device is configured to provide the first indication to the control port, and
wherein, in response to the control signal signifying a second upstream condition in which the power level of the first optical waveform is below the predetermined threshold, the control device is configured to provide the second indication to the control port.

3. The ILA module of claim 2, wherein the control device is configured to receive the control signal from an upstream Optical Performance Monitoring (OPM) device of the adjacent upstream optical element, the upstream OPM device being configured to analyze the power level of the first optical waveform with respect to the predetermined threshold, the predetermined threshold being associated with the first wavelength band.

4. The ILA module of claim 1, wherein outputting the first ASE waveform is configured to suppress a transient condition detected in the adjacent upstream optical element by substantially equalizing a power level at the output of the first amplifier.

5. The ILA module of claim 1, further comprising a second amplifier associated with a second wavelength band of the multiple wavelength bands,
wherein the second amplifier is configured to receive a second optical waveform from the adjacent upstream optical element via the upstream fiber span, the second optical waveform transmitted over the second wavelength band,
wherein, in response to obtaining a third indication that a power level of the second optical waveform is acceptable, the second amplifier is configured to output an amplified version of the second optical waveform according to characteristics of the second wavelength band, and
wherein, in response to obtaining a fourth indication that the power level of the second optical waveform is unacceptable, the second amplifier is configured to output a second ASE waveform according to the characteristics of the second wavelength band.

6. The ILA module of claim 5, further comprising a control device connected to a control port of the second amplifier,
wherein the control device is configured to receive a control signal from the adjacent upstream optical element,
wherein, in response to the control signal signifying a first upstream condition in which the power level of the second optical waveform is above a predetermined threshold, the control device is configured to provide the third indication to the control port, and
wherein, in response to the control signal signifying a second upstream condition in which the power level of the first optical waveform is below the predetermined threshold, the control device is configured to provide the fourth indication to the control port.

7. The ILA module of claim 5, wherein the first wavelength band is a C-band ranging from about 1525 nm to about 1565 nm, and the second wavelength band is an L-band ranging from about 1570 nm to about 1610 nm, wherein, when either the first optical waveform in the C-band or the second optical waveform in L-band is defective, a control device is configured cause an amplifier corresponding to the defective optical waveform to replace the defective optical waveform with its respective ASE waveform to reduce negative effects on a surviving wavelength band.

8. The ILA module of claim 1, wherein the multiple wavelength bands include two or more of a) an O-band ranging from about 1260 nm to about 1360 nm, b) an E-band ranging from about 1360 nm to about 1460 nm, c) an S-band ranging from about 1460 nm to about 1525 nm, d) a C-band ranging from about 1525 nm to about 1565 nm, e) an L-band ranging from about 1570 nm to about 1610 nm, and f) a U-band ranging from about 1625 nm to about 1675 nm, wherein, when one or more optical waveforms transmitted over the O-band, E-band, S-band, C-band, L-band, and U-band have a power level below a predetermined threshold for the respective wavelength band, a control device is configured to cause each corresponding amplifier to replace its defective optical waveform with its corresponding ASE waveform to reduce negative effects on one or more surviving wavelength bands.

9. The ILA module of claim 1, wherein a power level of the first ASE waveform is substantially the same as the power level of the first optical waveform when fully loaded with data channels.

10. The ILA module of claim 1, wherein, when an upstream issue is resolved by the adjacent upstream optical element to thereby change a status of the power level of the first optical waveform from unacceptable to acceptable, the first amplifier is configured to replace the first ASE waveform with the amplified version of the first optical waveform.

11. The ILA module of claim 1, wherein replacing the first optical waveform with the first ASE waveform is configured to reduce negative influences on one or more surviving wavelength bands having one or more power levels above corresponding predetermined thresholds.

12. The ILA module of claim 11, wherein reducing negative influences includes one or more of a) mitigating fluctuations in the one or more surviving wavelength bands, b) mitigating an impact of Stimulated Raman Scattering (SRS) in the one or more surviving wavelength bands, c) reducing a tilt effect in the one or more surviving wavelength bands, and d) improving a Signal-to-Noise Ratio (SNR) parameter in optical channels in the one or more surviving wavelength bands.

13. The ILA module of claim 1, further comprising a Dynamic Gain Flattening Filter (DGFF) connected to the output of the first amplifier, wherein a control device is further configured to reconfigure a target power profile of the DGFF based on a control signal received from the adjacent upstream optical element.

14. The ILA module of claim 13, further comprising a supplemental amplifier connected to an output of the DGFF, wherein each of the first amplifier and supplemental amplifier is an Erbium-Doped Fiber Amplifier (EDFA).

15. The ILA module of claim 1, further comprising an Optical Performance Monitoring (OPM) device connected to an output of the ILA module that leads to an adjacent downstream optical element via a downstream fiber span, wherein the OPM device is configured to transmit a downstream switching control signal to a downstream control device of the adjacent downstream optical element.

16. The ILA module of claim 15, wherein the OPM device is further configured to relay a control signal received from the adjacent upstream optical element to the downstream control device of the adjacent downstream optical element.

17. The ILA module of claim 15, wherein, upon the OPM device detecting a wavelength band of the multiple wavelength bands having a power level below a predetermined threshold, the OPM device configures the downstream switching control signal to instruct an associated amplifier to output an ASE waveform.

18. The ILA module of claim 15, wherein the adjacent downstream optical element is a terminal node having a demultiplexer and multiple receivers.

19. An optical element arranged in an optical line system configured for communicating signals within multiple wavelength bands, the optical element comprising:
multiple amplifiers, each amplifier configured to amplify an optical waveform within a respective wavelength band of the multiple wavelength bands; and
multiple Optical Performance Monitoring (OPM) devices, each OPM device connected to an output of a corresponding amplifier;
wherein each OPM device is configured to detect a power level of the respective optical waveform, such that, in response to determining that the power level falls below a predetermined threshold associated with the respective wavelength band, the respective OPM device is configured to send a control signal to a controller of an adjacent downstream optical element to instruct a corresponding amplifier to replace the respective optical waveform with an Amplified Spontaneous Emission (ASE) waveform.

20. The optical element of claim 19, wherein the optical element is configured as a) an In-Line Amplifier (ILA) module or b) a terminal node having multiple transmitters and a multiplexer.
